(19) United States
(12) Patent Application Publication
(10) Pub. No.: US 2010/0142496 A1
(43) Pub. Date: Jun. 10, 2010

(54) METHOD FOR DYNAMICALLY ALLOCATING SLOT AND APPARATUS THEREOF

(75) Inventors: Cheolhyo LEE, Daejeon (KR); Jae Young KIM, Daejeon (KR)

Correspondence Address: LADAS & PARRY LLP, 224 SOUTH MICHIGAN AVENUE, SUITE 1600, CHICAGO, IL, 60604, US

(73) Assignee: ELECTRONICS AND TELECOMMUNICATIONS RESEARCH INSTITUTE, Daejeon (KR)

(21) Appl. No.: 12/629,958

(22) Filed: Dec. 3, 2009

(30) Foreign Application Priority Data
Dec. 4, 2008 (KR) 10-2008-0122751
Apr. 9, 2009 (KR) 10-2009-0030989

(51) Int. Cl. H04J 3/00; H04W 72/04; H04B 7/212; H04J 3/16

(52) U.S. Cl. 370/337; 370/348; 370/443; 370/468

(57) ABSTRACT

Provided are a dynamic slot allocation method and an apparatus using the same. According to the present invention, a service class of a mobile terminal is determined based on speed information received from the mobile terminal. In addition, slots are allocated to the mobile terminal with different periods for updating location information according to a service class.

### CROSS-REFERENCE TO RELATED APPLICATION

This application claims priority to and the benefit of Korean Patent Application Nos. 10-2008-0122751 and 10-2009-0030989 filed in the Korean Intellectual Property Office on Dec. 4, 2008 and Apr. 9, 2009, the entire contents of which are incorporated herein by reference.

### BACKGROUND OF THE INVENTION

(a) Field of the Invention

The present invention relates to a method for dynamically allocating a slot and an apparatus performing the same. More particularly, it relates to a method for dynamically allocating a contention free period (CFP) slot and an apparatus performing the same in configuration of a medium access control (MAC) system that simultaneously uses a contention access period (CAP) and a CFP.

(b) Description of the Related Art

A wireless communication service can be grouped into several classes according to user's demands or quality of service (QoS). In order to satisfy the service requirement, a superframe in a wireless communication medium access control (MAC) may be divided into two periods, that is, a contention access period (CAP) and a contention free period (CFP).

In general, the CAP is provided to allow simultaneous access of several devices to a wireless media in expectation of a media access delay and a packet loss. In the CAP period, collision between devices in a wireless medium, such as wireless local area network (WLAN) and a wireless personal area network (WPAN), is monitored, and packets are transmitted when the collision does not occur. In addition, when a collision occurs, transmission is delayed to reduce collision probability.

In the CFP period, in the case that a packet loss should be small and in the case that a transmission delay time is predetermined, independent data transmission is allowed to two devices within a predetermined time period without interference of other devices.

Excluding a case in which a plurality of wireless communication frequency channels exist, the maximum usable slot numbers should be determined in advance for time-division slot allocation during the CFP when a single frequency channel is used. In this case, when the CFP is recklessly increased in a system where the CAP and the CFP coexist, devices using the CAP rarely have opportunities for packet transmission so that packet transmission performance in the network is significantly deteriorated. Therefore, the number of slots is determined in consideration of the maximum allowable devices for allocation of a large quantity of devices in the CFP.

As described, like the case of a WPAN or a wireless body area network (WBAN), since a number of physical channels that can be used in a CFP where a fixed channel is allocated for use is predetermined, the maximum allowable number of devices is limited in design of the system.

The WPAN allocates a time-division method-based slot, called the guaranteed time slot (GTS), to guarantee independent communication between two devices. However, the maximum usable number of GTSs within one superframe is limited to seven even though the GTS can be dynamically allocated. A communication system for real-time dynamic slot allocation for WPAN/WBAN can be applied to the WPAN, and a standard using the IEEE 802.15.4a distance estimation is currently completed and non-standard commercial products have been released.

Methods for GTS allocation, which is a function of the CFP in the WPAN, have been disclosed, but the number of allocable slot users and the number of physical slot numbers are set to be the same, and therefore dynamic user allocation cannot exceed the number of physical slots.

When the CFP exists, it is difficult to change the maximum number of physically usable slots because it is determined in system design. In this case, devices that access a channel at a particular time point are dynamically changed and therefore a small number of devices may be allocated to a slot for communication. However, in the case in which a number of devices that exceed the maximum number of usable slots simultaneously access the channel, some devices may not perform a communication function.

Moreover, if the probability of using the maximum number of slots during a substantial operation process is not high, it is preferable to allocate a number of slots rather than the maximum number of slots and efficiently operate slots in use.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a system that dynamically allocates a slot in a contention free period (CFP) by classifying service classes according to moving speed of a mobile terminal, and a method thereof.

According to an exemplary embodiment of the present invention, a dynamic slot allocation method is provided. The dynamic slot allocation method includes: determining a service class of a mobile terminal based on speed information of the mobile terminal received from the mobile terminal; and allocating slots with different update intervals for updating location information to the mobile terminal according to the service class.

According to another exemplary embodiment of the present invention, a dynamic slot allocating apparatus is provided. The dynamic slot allocating apparatus includes: a determination unit that determines a service class of a mobile terminal based on speed information received from the mobile terminal; and an allocation unit that allocates slots with different periods for location information update to the mobile terminal according to the service class.

### BRIEF DESCRIPTION OF THE DRAWINGS

FIG. 1 is a schematic diagram of a location tracking network system according to an exemplary embodiment of the present invention.

FIG. 2 is a block diagram of detailed configurations of MN, RN, and CN according to an exemplary embodiment of the present invention

FIG. 3 shows a superframe structure according to the exemplary embodiment of the present invention.

FIG. 4 shows a parameter structure according to the exemplary embodiment of the present invention.

FIG. 5 shows a slot reservation matrix according to the exemplary embodiment of the present invention.

FIG. 6 is a flowchart of a dynamic slot allocation method according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise” and variations such as “comprises” or “comprising” will be understood to imply the inclusion of stated elements but not the exclusion of any other elements.

In this specification, a mobile terminal may refer to a terminal, a mobile station (MS), a subscriber station (SS), a portable subscriber station (PSS), user equipment (UE), or an access terminal (AT). The mobile terminal may include all or part of the functions of the mobile station, the subscriber station, the portable subscriber station, and the user equipment.

Hereinafter, a dynamic slot allocation method and an apparatus performing the same according to an exemplary embodiment of the present invention will be described in further detail with reference to the drawings.

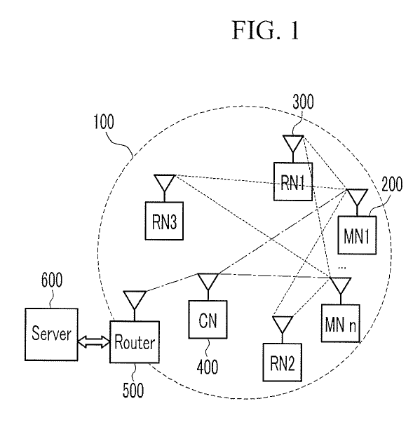

FIG. 1 is a schematic diagram of a location tracking network system according to an exemplary embodiment of the present invention.

Referring to FIG. 1, a single location tracking network 100 requires four constituent elements for measuring a distance and transmitting data. That is, the location tracking network 100 includes a mobile node (MN) 200, a reference node (RN) 300, a coordinator node (CN) 400, a router 500, and a server 600. Here, the MN may be also referred to as a mobile terminal.

The MN 200 is attached to a mobile object to check a location thereof. The RN 300 is a reference device in distance measurement for checking the location of the MN 200. The CN 400 collects data, transmits a beacon, and manages the location tracking network 100. The router 500 sets a data path for transmitting data collected by the CN 400 to the server 600. The server 600 operates a location of the MN 200 based on the data collected by the CN 400 and received through the router 500. In addition, the server 600 manages conditions and locations of several devices in the location tracking network 100.

If it is assumed that one location tracking network 100 can serve n MNs 200 to the maximum, each MN 200 acquires distance data measured by the RN 300 and transmits the distance data to the CN 400. However, the MN 200 often inflows from a neighboring network or outflows to a moving network, and therefore the number of MNs 200 existing in the location tracking network 100 is not fixed.

If an MN 200 exists, the CN 400 determines whether the MN 200 moves at a high speed or a low speed by using the moving speed during a specific time period and acceleration information in order to classify a service class. An MN 200 having a class of high priority is allocated first, and a slot allocation period of an MN 200 having a class of low priority is dynamically controlled. That is, the number of slots for receiving priority to a service of a high-speed MN is predetermined in the CFP. In addition, in the case of a service of a low-speed MN, a speed update cycle is increased to accept a number of MNs 200 that is greater than the number of allocated physical slots. Therefore, a number of allocated slots is increased to track a number of MNs 200 that is greater than the maximum number of acceptable physical slots by minimizing one slot time interval so that the slot use efficiency can be increased.

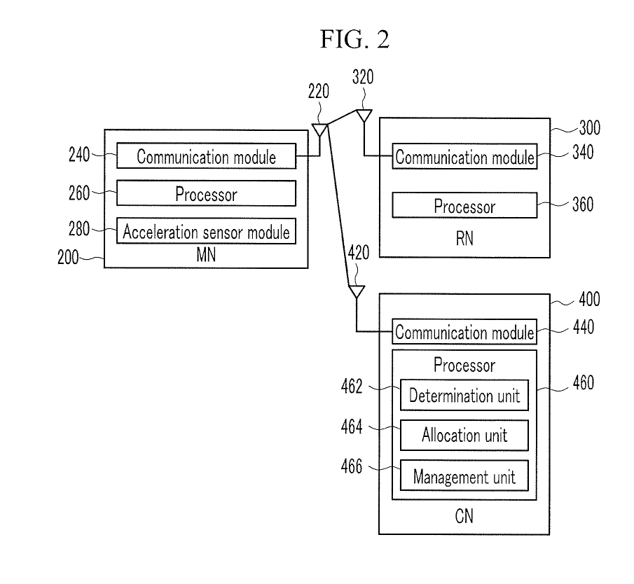

FIG. 2 is a block diagram of a detailed configuration of the respective MN, RN, and CN in connection therebetween according to the exemplary embodiment of the present invention.

Referring to FIG. 2, the MN 200 includes an antenna 220, a communication module 240 formed of a modem that is capable of communication and ranging, a processor 260 for processing data, and an acceleration sensor module 280 for sensing speed variation.

The processor 260 of the MN 200 performs a data communication function and a distance measuring function within the location tracking network 100. In this case, a method for distance calculation includes various methods using ultrasonic waves, radio frequency (RF), and laser. Unlike a system having a communication module and a device measurement module that are divided by hardware, such as an ultrasonic wave system, a system using a received signal strength intensity (RSSI) of the RF may be considered even though distance accuracy is low. Alternatively, like the IEEE 802.15.4a, that is, a case of using an impulse-based ultra wideband (UWB), a system having a communication module that can perform distance measurement and communication may be considered. Particularly, in order to determine a service class by using acceleration and average speed information of the MN 200, accurate distance and location measurement information is required. In this case, an IEEE 802.15.4a based impulse UWB system is more suitable since it has distance precision of several centimeters.

In addition, the processor 260 senses speed variation of the processor 260 to actively control data transmitting/receiving. In order to check movement of the MN 200, an average speed during a predetermined time period should be checked. However, operation capability of the MN 200 is insufficient for calculating a location of the MN 200 and updating speed. In order to detect movement of the MN 200, the processor 260 calculates instantaneous movement information of the MN 200 by using the acceleration sensor module 280 and transmits the calculated information to the CN 400. In this case, the acceleration sensor module 280 outputs acceleration information, that is, the speed variation amount of a target object (i.e., MN 200).

The RN 300 includes an antenna 320, a communication module 340 formed of a modem that is capable of communication and ranging, and a processor 360 for data processing.

The CN 400 includes an antenna 420, a communication module 440 formed of a modem that is capable of communication and ranging, and a processor 460 for data processing.

The processor 460 detects location change of the MN 200 and changes a slot. That is, when the MN 200 is stopped at a predetermined location, a location information update interval is set to be long. In addition, when the movement of the MN 200 is detected, the update interval is set to be short in order to efficiently manage use of the slot. However, when the MN 200 moves with uniform velocity, the output of the acceleration sensor module 280 is too small to detect the location change so that information on a movement distance per time is continuously updated.

The processor 460 includes a determination unit 462, an allocation unit 464, and a management unit 466.

The determination unit 462 determines a service class of the MN 200 based on speed information of the MN 200 and received from the MN 200.

The allocation unit 464 allocates a slot with a different period for location information update to the MN 200 according to the determined service class. In this case, the allocation unit 464 allocates first to a moving device that is determined to be a first service class for location information update for each beacon period. In addition, the allocation unit 464 allocates a slot to a moving device that is determined to be a second service class that is inferior to the first service class for location information update for each predetermined period that is longer than the beacon period.

Hereinafter, the first service class refers to an H class that is classified when the MN 200 is in high speed. In addition, the second service class refers to an L class that is classified when the MN 200 is in low speed.

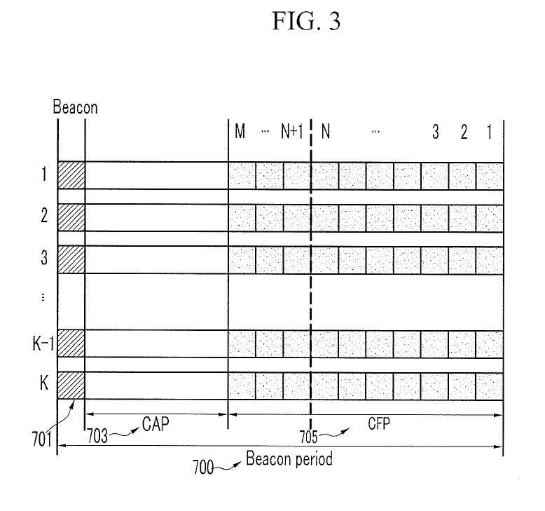

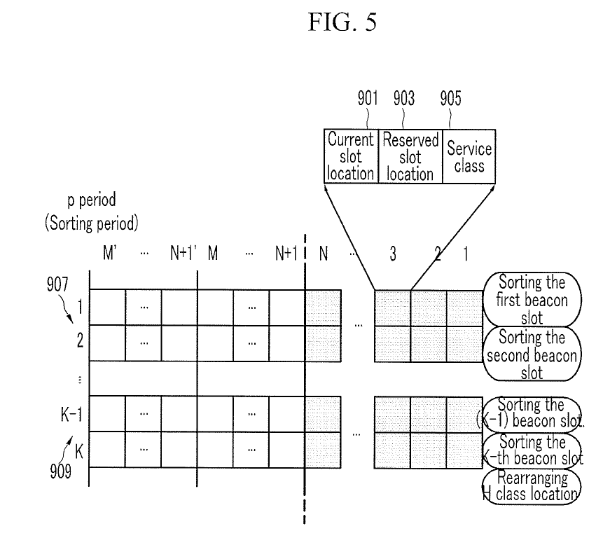

The number of slots for the location information update for each beacon period is from 1 to N in FIG. 3. In addition, the number of slots for the location information update for the predetermined period that is longer than the beacon period is N+1 to M in FIG. 3 or from N+1 to M and from N′+1 to M′ in FIG. 5.

The management unit 466 manages a slot reservation matrix in which slot information including a current slot location, a reserved slot location, and a service class is formed for each slot. The slot reservation matrix will be described in further detail with reference to FIG. 5.

FIG. 3 shows a structure of the superframe according to the exemplary embodiment of the present invention.

A superframe of a medium access control (MAC) for wireless communication is classified into a contention access period CAP during which collision of devices in a network is allowed for increasing usage of each device, and a contention free period CFP during which only one device uses a channel for an individually specified period.

Therefore, FIG. 3 shows CAP and CFP allocation and a slot allocation structure in the structure of the superframe.

According to the FIG. 3, parameters for slot allocation of the superframe can be defined as follows.
M: total number of slots that can be physically allocated to a single slot
N: threshold value of an H class slot that can be logically received
P: defined by M-N and represents the number of slots shared by moving devices for their necessity in a single beacon. One slot is set to be shared by two MNs 200 during 2K interval.
K: total number of beacons formed of several superframes and normally updating the speed of the MN 200.
service class: H class (high-speed), L class (low-speed) One of matters that the location tracking network system should determine is how often to update location information according to the maximum speed of a tracking target MN 200. In this case, an update interval is a superframe unit. Therefore, it is defined that a location information of the MN 200 is updated every K superframes.

The CN 400 determines a beacon period 700 first. Then, the CN 400 allocates a CAP 703 and a CFP 705 according to the number of trackable MNs 200.

The CN 400 informs the start of each superframe by transmitting the beacon 701 for every predetermined period. The CN 400 includes information for managing an MN 200 that uses the superframe in the beacon 701.

In the CFP 705, slot allocation may be set to allocate a necessary amount of slots upon a slot allocation request. However, the maximum number of physical slots that can be allocated within one superframe is limited to M.

In this case, the slot is classified according to a service class. The service class is divided into an H class for receiving an MN 200 that is relatively fast in speed and an L class for an MN 200 that is relatively slow in speed. According to a reference for division of the service class, when a moving speed of an MN 200 is fast so that location information of the MN 200 needs to be updated for every K beacon periods, the MN 200 is classified into the H class. In addition, when a moving speed of the MN 200 is relatively slow so that the location information is updated for every period that is longer than K beacon periods, the MN 200 is classified into the L class. In this case, the period that is longer than the K beacon periods may be defined as p*K (where p is an integer greater than 1).

The service class depends on the speed of the MN 200 for a specific time period, and therefore a state of the service class varies.

The H class is defined to include N slots (N is a threshold value) among total M slots which are able to be allocated in one superframe. When the number of H classes allocated in one superframe exceeds N, an update cycle of a MN that has been classified into the H class is set to long as in the L class even though there is a loss in location update accuracy. Such a classification of the service class may be more specified.

In the case that p=2, the number of logically allocable devices by sharing the number of physically allocable devices and slots can be represented as shown in the following equation.

S (maximum number of allocable devices):=M*K+p*K

Sⁿ (maximum number of physical slots):=M*K

In order to set a threshold value N, moving speed, distribution, and movement characteristics of the MNs 200 in the network are estimated for selecting an optimum threshold value N. For determination of the threshold value N, a statistical method using moving speed and distribution of several MNs 200 for a specific time period may be used.

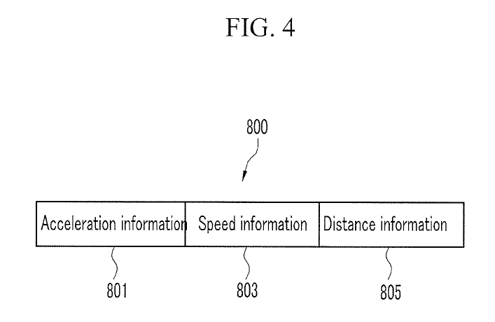

FIG. 4 shows a parameter structure according to the exemplary embodiment of the present invention. Particularly, FIG. 4 shows a parameter structure that is additionally required between the MN 200 and the CN 400.

Referring to FIG. 4, a parameter 800 includes acceleration information 801, speed information 803, and distance information 805.

A packet used for medium access control (MAC) communication includes basic information such as frame control, an address field, and a payload used in a packet header of a WPAN. However, the MN 200 transmits the parameter 800 in addition to the basic information to the CN 400. The CN 400 uses the information included in the parameter 800 for service class definition and service class classification for dynamic slot allocation.

FIG. 5 shows a slot reservation matrix according to the exemplary embodiment of the present invention.

Referring to FIG. 5, the CN 400 manages a slot reservation matrix. The slot reservation matrix is a matrix representing reserved slots for changing service class types of currently allocated slots and location of the allocated slots in the future.

The CN 400 allocates a slot to the MN 200 according to a service class and arranges slots through the slot reservation matrix.

Each slot (1, . . . , N) includes three sets of information, that is, a current slot location 901, a reserved slot location 903, and a service class 905.

The current slot location 901 indicates which slot is. The reserved slot location 903 reserves a location of a changed slot through slot sorting and movement of another beacon to a slot. The service class 905 collects information on whether the slot is the H class or the L class according to moving speed.

The slot reservation matrix includes slot information from a first beacon period 907 to a K-th beacon period 909.

Here, in the first beacon period 907, as an example, 1 to N slots operate in the H class.

In addition, since the number of logical slots in the beacon period is defined to M+P, the slot reservation matrix records information of all the logical slots. Therefore, the slot reservation matrix includes information on N+1 to M and N+1′ to M′. Here, since from N+1 to M slots and from N+1′ to M′ slots share physical slots, they alternately update location information at every 2*K beacon period.

In addition, slot arrangement is performed every beacon period, and distance information during a substantial superframe period for slots allocated to the first beacon period is exchanged. When the superframe period has expired, the slots are grouped into the H class and the L class according to service classes thereof. This process is repeated to the K-th beacon so as to arrange slots in each beacon period.

After the K-th beacon period, H classes exceeding N located in each beacon period are moved to an empty H service slot within N by searching each beacon period. In this case, when an L class is located in a location for the movement, the two slots exchange their locations.

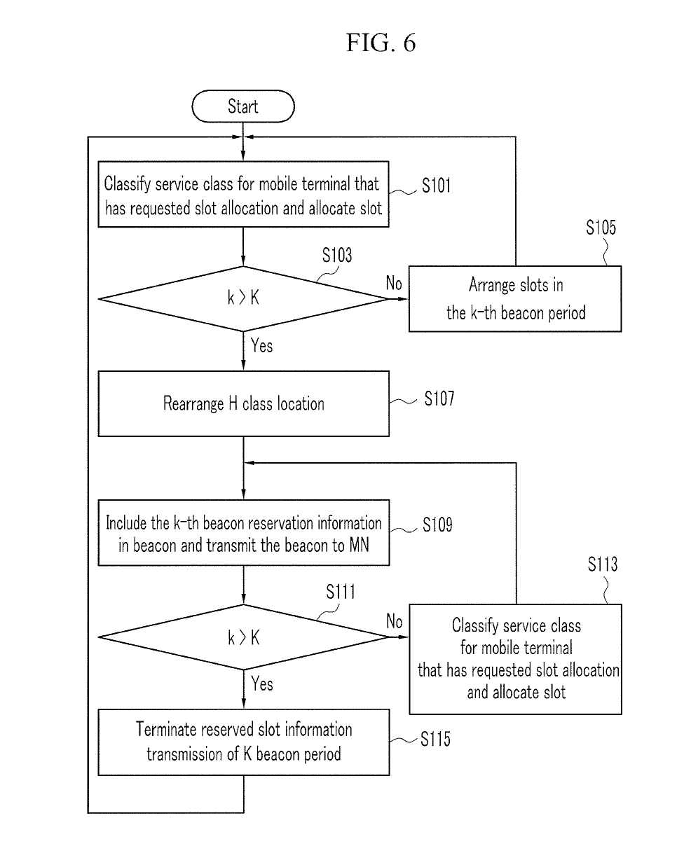

FIG. 6 is a flowchart for dynamic slot allocation according to an exemplary embodiment of the present invention.

Referring to FIG. 6, a slot allocation process is divided into a slot sorting process and a slot reservation process. In this case, each process is performed in K beacon periods. That is, 2K periods are required for finishing all slot reservation functions, and therefore, the minimum update available period is set to 2K in the system design.

In the slot sorting process, a service class of a moving device that has requested slot allocation is classified first, and slot allocation according to the service class is performed (S101). The step of S101 is performed at each beacon period of a superframe.

Slot sorting is performed according to a service class in a given beacon, and this is performed for the entire K beacon periods. That is, it is determined whether a slot number k is greater than K (S103). If the slot number k is not greater than K, slots of the k-th beacon period are sorted (S105), and then the step of S101 is performed. If the slot number k is greater than K, a slot location is rearranged (S107). For an H class exceeding N, the entire beacon periods are searched to move the slot to an empty H class within N or exchange a location with a slot occupied by an L class.

According to the slot reservation process after the slot sorting process, reserved slot information is included in the first beacon period of which a slot location is changed due to rearrangement in the step of S107 (S109). It is determined whether a number K of the slot is greater than K (S111) and service class classification and slot allocation for a MN that has requested a slot allocation are performed in the corresponding beacon (S113). If the number k of the slot is greater than K, that is, the slot rearrangement is performed during a K beacon period, the slot reservation process is terminated (S115). This process is repeated every 2K periods.

According to the exemplary embodiment of the present invention, slots can be efficiently allocated and managed for a plurality of simultaneously accessing devices when, among media access control functions where the CAP and CFP coexist, real-time location tracking of a mobile terminal is performed. That is, although the maximum number of physically usable slots is fixed in system design, a number of devices more than the fixed number of slots can be received by defining service classes according to frequency in use of the devices.

Therefore, a number of devices more than the number of physical slots can be received by suggesting a method for utilizing more than the maximum number of physical slots that can be allocated as the number of slots allocated to a mobile terminal.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A dynamic slot allocation method comprising:
determining a service class of a mobile terminal based on speed information of the mobile terminal received from the mobile terminal; and
allocating slots with different update intervals for updating location information to the mobile terminal according to the service class.

2. The dynamic slot allocation method of claim 1, wherein, in the allocating slots with different update intervals,
a plurality of slot periods are respectively allocated to a plurality of service classes that are determined based on the speed information from a service class having highest priory in sequential order, and
the plurality of slot periods include a slot period for updating location information at each beacon period to be allocated to the service class having the highest priority, and at least one slot period for updating location information at every predetermined period that is longer than the beacon period to be allocated to the rest of the service classes.

3. The dynamic slot allocation method of claim 2, wherein the at least one slot period for updating the location information at every predetermined period that is longer than the beacon period is a slot period where a plurality of mobile terminals share a single slot.

4. The dynamic slot allocation method of claim 2, further comprising, before the determining of the service class,
setting a slot reservation matrix where slot information including a current slot location, a reserved slot location, and a service class is formed for each slot, wherein the slot reservation matrix is used to allocate a slot to the mobile terminal according to the service class.

5. The dynamic slot allocation method of claim 3, further comprising, before the determining of the service class,
setting a slot reservation matrix where slot information including a current slot location, a reserved slot location, and a service class is formed for each slot, wherein the slot reservation matrix is used to allocate a slot to the mobile terminal according to the service class.

6. The dynamic slot allocation method of claim 4, further comprising, after the allocating slots with different period:
rearranging slot locations in the case that an empty slot exists in slot periods for updating location information at every beacon period or in the case that a slot allocated to a mobile terminal of which a service class has the highest priority among the at least one slot period for updating location information at every predetermined period that is longer than the beacon period exists; and
including reserved slot information allocated to each mobile terminal checked through the slot reservation matrix in a beacon, and transmitting the beacon to the corresponding mobile terminal.

7. The dynamic slot allocation method of claim 6, wherein, in the determining of the service class, a packet which is for exchanging information for media access control communication and includes a parameter including speed information of the mobile terminal is received from the moving terminal.

8. A dynamic slot allocating apparatus comprising:
a determination unit that determines a service class of a mobile terminal based on speed information received from the mobile terminal; and
an allocation unit that allocates slots with different periods for location information update to the mobile terminal according to the service class.

9. The dynamic slot allocating apparatus of claim 8, wherein the allocation unit allocates slot periods respectively corresponding to the service classes determined based on the speed information from a service having the highest priority in sequential order, and the slot period includes a slot period for updating location information at each beacon period to be allocated to the service class having the highest priority and at least one slot period for updating location information at every predetermined period that is longer than the beacon period to be allocated to the rest of the service classes.

10. The dynamic slot allocating apparatus of claim 9, further comprising a management unit that manages a slot reservation matrix where slot information including a current slot location, a reserved slot location, and a service class is formed for each slot.

11. The dynamic slot allocating apparatus of claim 10, wherein, after a slot is allocated to the mobile terminal by using the slot reservation matrix, the allocation unit rearranges slot locations in the case that an empty slot exists in slot periods for updating location information at every beacon period or in the case that a slot allocated to a mobile terminal of which a service class has the highest priority among the at least one slot period for updating location information at every predetermined period that is longer than the beacon period exists, and includes reserved slot information allocated to each moving slot checked through the slot reservation matrix in a beacon, and transmits the beacon.
